(19) United States
(12) Patent Application Publication
(10) Pub. No.: US 2026/0104138 A1
(43) Pub. Date: Apr. 16, 2026

(54) NO-DRILL WINDOW TREATMENT MOUNTING SYSTEM AND NO-DRILL WINDOW TREATMENT

(71) Applicant: Jianmin Guan, Foshan (CN)

(72) Inventor: Jianmin Guan, Foshan (CN)

(21) Appl. No.: 19/422,493

(22) Filed: Dec. 17, 2025

(30) Foreign Application Priority Data
Sep. 6, 2025 (CN) 202521924605.X

(51) Int. Cl. F16M 13/02

(52) U.S. Cl. CPC F16M 13/02

(57) ABSTRACT

A no-drill window treatment mounting system includes a window treatment bracket rod and a window treatment bracket connector. The window treatment bracket connector includes: a mounting housing, having an outer side connected to the window treatment bracket rod, and provided with a mounting space extending in a first direction; a support connecting assembly, accommodated in the mounting space in a relative sliding manner in the first direction, and having a first end extending out of the mounting space and an opposite second end provided with a first pushing surface; and an operation connecting assembly, mounted in the mounting housing, having a first end configured as an operation end and an opposite second end provided with a second pushing surface, and provided with a speed-reduction transmission structure, whereby a mounting process is convenient and stepless adjustment is achieved. This application further provides a no-drill window treatment applying the mounting system.

### TECHNICAL FIELD

The present disclosure relates to the technical field of window treatment mounting, and in particular, to a no-drill window treatment mounting system and a no-drill window treatment.

### BACKGROUND

Window treatments are widely used in residential and office settings, primarily for the purpose of adjusting indoor lighting. Commonly used window treatment varieties include roller blinds, venetian blinds, and honeycomb shades. Typically, these window treatments are mounted using mounting brackets, screws, and other fastening elements to secure them to the window frame. Since screws create holes in the window frame, remounting or replacement requires additional drilling and prevents mounting in the exact original position. Each replacement inevitably leaves multiple screw holes in the wall surrounding the window frame. This not only damages the wall structure, which is difficult to restore, but also compromises aesthetic appeal. Consequently, no-drill window treatments have emerged in the market. However, existing no-drill structures often suffer from complex designs and cumbersome locking mechanisms, leading to increased mounting difficulty. Furthermore, the adjustment range of these no-drill structures is limited and lacks precision. Many rely on tension rods or simple threaded rods for extension, which cannot provide sufficient support force and fail to achieve stepless adjustment. This results in insufficient mounting accuracy. Particularly in narrow window frames or corner areas, using conventional no-drill brackets proves highly inconvenient. Therefore, it is necessary to propose an improved effective technical solution.

### SUMMARY

In view of the above defects in the prior art, an objective of the present disclosure is to provide a no-drill window treatment mounting system and a no-drill window treatment. By means of a uniquely designed input-output speed-reduction transmission structure with opposing directions, the system enables precise, stepless adjustment of a support connecting assembly, and the system can be widely applied to the mounting of window treatment brackets, eliminating the need for wall drilling and offering convenient mounting and operation.

To achieve the above purpose and other related purposes, the present disclosure provides the following technical solutions.

A first aspect of the embodiments of the present disclosure provides a no-drill window treatment mounting system, including: a window treatment bracket rod extending in a first direction and one or two window treatment bracket connectors adaptively connected to an end portion of the window treatment bracket rod, where the window treatment bracket connector includes:
a mounting housing, where the mounting housing is adaptively connected to the window treatment bracket rod, and provided with a mounting space that extends away from the window treatment bracket rod in the first direction and communicates with outside;
a support connecting assembly, where the support connecting assembly is accommodated in the mounting space in a relative sliding manner in the first direction, and has a first end extending out of the mounting space and an opposite second end provided with a first pushing surface obliquely oriented relative to the first direction; and
an operation connecting assembly, where the operation connecting assembly is mounted in the mounting housing, has a first end configured as an operation end and an opposite second end provided with a second pushing surface in pushing fit with the first pushing surface, and is provided with a speed-reduction transmission structure extending in a second direction intersecting with the first direction, whereby the second pushing surface moves relatively in the second direction.

In an embodiment of the present disclosure, the first direction is an axial direction of the window treatment bracket rod, the second direction is substantially perpendicular to the first direction, and the first pushing surface is arranged within an angle between the first direction and the second direction.

In an embodiment of the present disclosure, the support connecting assembly includes:
a support base, where the support base includes a connecting portion partially accommodated in the mounting space and a support portion that is connected to the connecting portion and that extends out of the mounting space in the first direction; and
a pushing rod, where the pushing rod is movably accommodated in the mounting space in the first direction, one end of the pushing rod is connected to the connecting portion, and the first pushing surface is arranged at another end of the pushing rod away from the connecting portion.

In an embodiment of the present disclosure, the pushing rod and the support portion are in insertion fit, and the support connecting assembly further includes an elastic member arranged between the pushing rod and the support portion.

In an embodiment of the present disclosure, the pushing rod is provided with a mounting socket, the support portion is configured as a columnar body slidably sleeved over the mounting socket, the elastic member is disposed in the mounting socket, and two ends of the elastic member abut against an interior of the pushing rod and the support portion, respectively.

In an embodiment of the present disclosure, the pushing rod is provided with a connecting slide groove, the support portion is provided with a limiting column extending outwards, and the limiting column is slidably limited in the connecting slide groove.

In an embodiment of the present disclosure, the support connecting assembly further includes a support adjustment member, the support adjustment member is detachably connected to an end of the pushing rod away from the support base, and the first pushing surface is formed at an end of the support adjustment member away from the support base.

In an embodiment of the present disclosure, the support adjustment member is provided with a first sliding column, and the mounting housing is provided with a first slide groove that extends in the first direction and that is matched with the first sliding column; and/or,
the support adjustment member and the pushing rod are provided with slidable connecting structures or quick-release snap structures matched with each other.

In an embodiment of the present disclosure, the operation connecting assembly is provided with the second pushing surface in pushing fit with the first pushing surface, the operation connecting assembly is provided with a second sliding column, and the mounting housing is provided with a second slide groove that extends in the second direction and that is matched with the second sliding column.

In an embodiment of the present disclosure, the operation connecting assembly includes an operation screw and a pushing driving member, the operation screw is rotatably connected to the mounting housing and is threadedly connected to the pushing driving member, the second pushing surface is arranged on the pushing driving member, and the operation screw is capable of being controlled to rotate to drive the pushing driving member to move in the second direction.

In an embodiment of the present disclosure, an adjustment nut is embedded in the pushing driving member, the operation screw is threadedly connected to the adjustment nut, and a head of the operation screw is rotatably assembled into the mounting housing; and/or,
the support portion is provided with a first slot adjacent to the first pushing surface, and the pushing driving member is provided with a second slot that is snap-fitted and slidably connected to the first slot and that is adjacent to the second pushing surface.

In an embodiment of the present disclosure, a side of a part of the mounting housing corresponding to the mounting space is open and is detachably connected to a cover; and/or,
an edge of the mounting housing is further provided with a strip snap-fitted with the window treatment bracket rod.

A second aspect of the embodiments of the present disclosure provides a no-drill window treatment, including: the no-drill window treatment mounting system according to the first aspect of the present disclosure and a window treatment body, where the window treatment body is mounted to the window treatment bracket rod.

As stated above, the present disclosure has the following beneficial effects:
Embodiments of the present disclosure provide a no-drill window treatment mounting system and a no-drill window treatment. Through lateral operational input (where simply rotating or pressing an operation end on the side completes support adjustment), a speed-reduction transmission structure converts this lateral operation into a minimal-displacement axial output. An oblique pushing surface is configured to transform lateral displacement into thrust along the axial direction of the window treatment rod, thereby driving a support assembly to press outward firmly against the wall. Furthermore, the support assembly incorporates an elastic member, which not only secures the system against the wall without damage by outward pressing force but also enables automatic resetting and provides buffering, thereby enhancing stability and adaptability. Additionally, replaceable pushing blocks are included to adapt to various angles and different wall surfaces.

### BRIEF DESCRIPTION OF THE DRAWINGS

FIG. 1 is a schematic diagram of assembly of a no-drill window treatment mounting system according to embodiments of the present disclosure;

FIG. 2 is a stereoscopic schematic structural diagram of a window treatment bracket connector in a no-drill window treatment mounting system according to embodiments of the present disclosure;

FIG. 3 is an exploded schematic structural diagram of a window treatment bracket connector in a no-drill window treatment mounting system according to embodiments of the present disclosure;

FIG. 4 is a schematic structural diagram of a support connecting assembly in a no-drill window treatment mounting system according to embodiments of the present disclosure; and

FIG. 5 is a schematic structural diagram of a pushing driving member and a support adjustment member in a no-drill window treatment mounting system according to embodiments of the present disclosure.

### REFERENCE NUMERALS

10. Mounting housing; 11. Mounting space; 12. First slide groove; 13. Second slide groove; 14. Cover; 15. Strip; 20. Support connecting assembly; 21. Pushing rod; 211. First pushing surface; 212. Mounting socket; 213. Connecting slide groove; 214. Support adjustment member; 215. First sliding column; 216. First slot; 22. Support base; 221. Connecting portion; 222. Support portion; 23. Elastic member; 24. Limiting column; 30. Operation connecting assembly; 35. Pushing driving member; 31. Second pushing surface; 32. Second sliding column; 33. Adjustment nut; 34. Second slot; 40. Adjustment screw; and 50. Window treatment bracket rod.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. It should be understood that the present application is not limited by the examples and embodiments publicly described herein. All other embodiments obtained by a person of ordinary skill in the art based on the embodiments of the present application without creative efforts shall fall within the protection scope of the present application.

In the description of the present disclosure, it should be understood that orientations or position relationships indicated by terms “length”, “width”, “upper”, “lower”, “front”, “rear”, “left”, “right”, “vertical”, “horizontal”, “top”, “bottom”, “inside”, “outside”, and the like are orientations or position relationships as shown in the drawings, for ease of describing the present disclosure and simplifying the description, rather than indicating or implying that the mentioned devices or elements must have a specific orientation and must be established and operated in a specific orientation, and thus, these terms cannot be understood as a limitation to the present disclosure.

In addition, the terms “first” and “second” are merely intended for a purpose of description, and shall not be understood as an indication or implication of relative importance or implicit indication of a quantity of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the connection may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

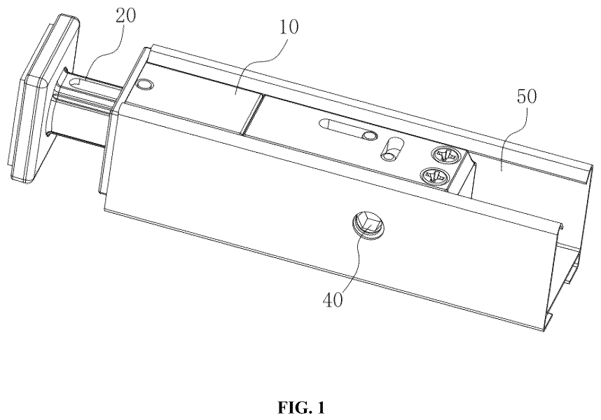

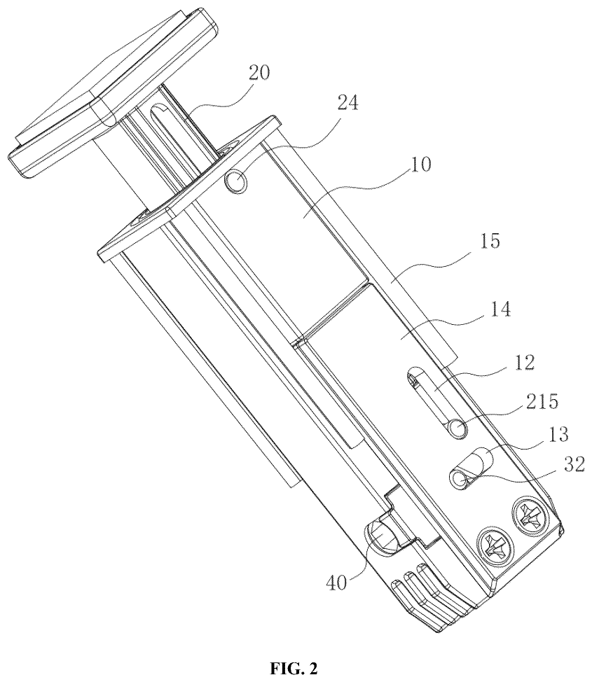

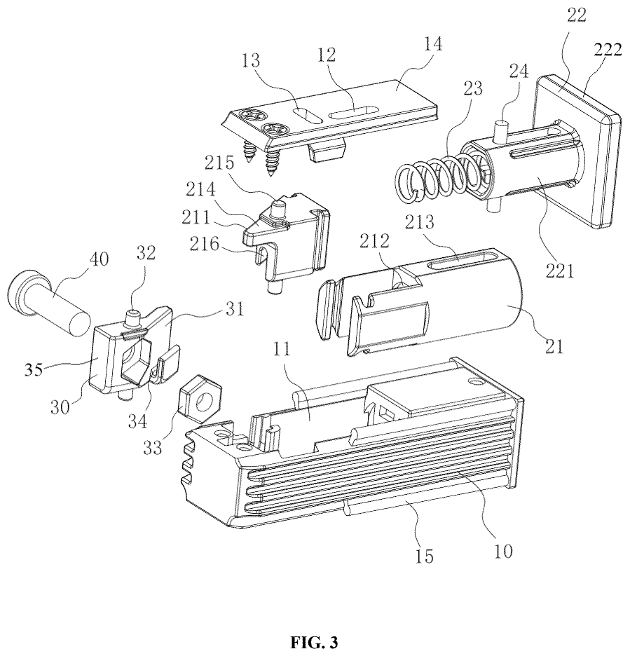

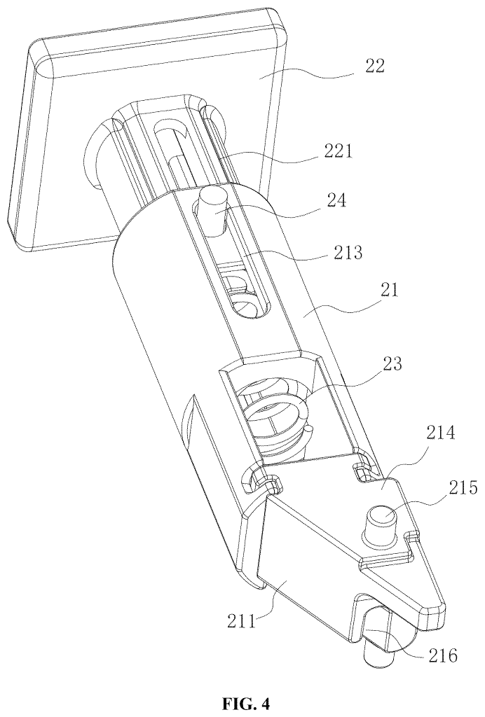

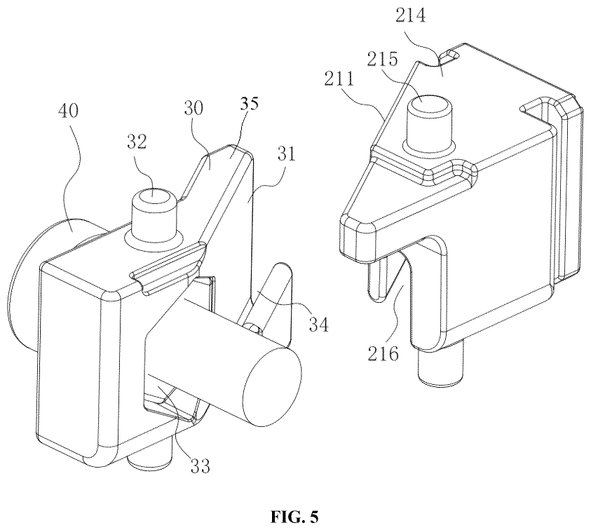

Please referring to FIG. 1 to FIG. 5, a first aspect of the present disclosure provides a no-drill window treatment mounting system, including: a window treatment bracket rod 50 extending in a first direction and one or two window treatment bracket connectors 100 adaptively connected to an end portion of the window treatment bracket rod 50. The window treatment bracket connector 100 includes:
a mounting housing 10, adaptively connected to the window treatment bracket rod 50, and provided with a mounting space 11 extending away from the window treatment bracket rod 50 in the first direction and communicating with the outside;
a support connecting assembly 20, accommodated in the mounting space 11 in a relative sliding manner in the first direction, and having a first end extending out of the mounting space 11 and an opposite second end provided with a first pushing surface 211 obliquely oriented relative to the first direction; and
an operation connecting assembly 30, mounted in the mounting housing 10, having a first end configured as an operation end and an opposite second end provided with a second pushing surface 31 in pushing fit with the first pushing surface 211, and provided with a speed-reduction transmission structure extending in a second direction intersecting with the first direction, whereby the second pushing surface moves relatively in the second direction.

When the above technical solution is implemented to perform window treatment mounting, one window treatment bracket connector 100 is first snap-fitted to each of two ends of the window treatment bracket rod 50. In an initial state, the support connecting assembly 20 is slightly shrunk in the mounting housing 10 to place the window treatment bracket rod 50 to a mounting position, and then the operation connecting assembly 30 is controlled to perform speed-reduction transmission, to push the support connecting assembly 20 outwards through the first pushing surface 211 until the support connecting assembly 20 abuts against a mounting wall surface, fixing the window treatment bracket rod 50, achieving a more convenient mounting process. The position of the support connecting assembly 20 is adjusted by means of speed-reduction transmission, whereby stepless adjustment can be implemented, and the adjustment process is more precise.

The mounting housing 10 is provided with a part corresponding to the window treatment bracket rod 50 in the first direction, specifically, the part can be compounded with the first direction or parallel to the first direction. For example, the mounting housing 10 passes through the window treatment bracket rod 50, and axial directions of both are coincident. It can be understood that the mounting housing 10 and the window treatment bracket rod 50 can also be connected through mutual extending ends. Alternatively, the mounting housing 10 is configured as a bent structure, and is provided with a part coaxial with the window treatment bracket rod 50 and a mounting section staggered from the window treatment bracket rod 50 but substantially parallel to the axial direction of the window treatment bracket rod 50, and the mounting space 11 is arranged on the mounting section. In this way, the no-drill window treatment mounting system can be adapted to different wall surface forms, e.g., mounted to a corner wall surface.

Specifically, the first direction is an axial direction of the window treatment bracket rod 50, the second direction is substantially perpendicular to the first direction, and the first pushing surface 211 is arranged within an angle between the first direction and the second direction. It can be understood that the window treatment bracket rod 50 and the window treatment bracket connector 100 are coaxial, and the first direction is an axial direction of the mounting housing 10, is the axial direction of the window treatment bracket rod 50, and is also an adjustment direction in which the window treatment bracket connector 100 is controlled to be telescopically adjusted to realize no-drill operations. The second direction perpendicularly intersects with the first direction. That is, the window treatment bracket connector 100 is adjusted by laterally adjusting the operation connecting assembly 30, facilitating operations. In addition, the first pushing surface 211 is arranged within the angle between the first direction and the second direction, optimizing spatial arrangement of the whole structure. It can be understood that the first direction and the second direction are not limited to be perpendicular to each other, for example, the two can be set at 80°, 100°, 120°, etc., also meeting lateral adjustment requirements.

Further, the support connecting assembly 20 includes:
a support base 22, including a connecting portion 221 partially accommodated in the mounting space 11 and a support portion 222 connected to the connecting portion 221 and extending out of the mounting space 11 in the first direction; and
a pushing rod 21, movably accommodated in the mounting space 11 in the first direction, and having one end connected to the connecting portion 221, the first pushing surface 211 being arranged at another end of the pushing rod 21 away from the connecting portion 221.

The support base 22 is specifically arranged outside the mounting space 11 and is configured to increase a support contact area to be in support fit with an external support (such as a wall surface). The pushing rod 21 implements a telescopic pushing action inside the mounting space 11.

Furthermore, the pushing rod 21 and the support portion 222 are in insertion fit, and the support connecting assembly 20 further includes an elastic member 23 arranged between the pushing rod 21 and the support portion 222.

By providing the elastic member 23, a pretightening force can be set for the support connecting assembly 20, whereby the compressed assembly is released before adjustment and mounting to be accurately placed at a target position. Under further adjustment, the support base 22 of the support connecting assembly 20 extends outwards for powerful supporting. On the other hand, in a support state, the elastic member 23 can also absorb energy and reduce vibration, avoiding a rigid structure from being easily damaged.

Furthermore, the pushing rod 21 is provided with a mounting socket 212, the support portion 222 is configured as a columnar body slidably sleeved over the mounting socket 212, the elastic member 23 is disposed in the mounting socket 212, and two ends of the elastic member 23 abut against the interior of the pushing rod 21 and the support portion 222, respectively.

The sleeving structure realizes slidable connection between the pushing rod 21 and the support base 22, and can realize axial positioning.

Furthermore, the pushing rod 21 is provided with a connecting slide groove 213, the support portion 222 is provided with a limiting column 24 extending outwards, and the limiting column 24 is slidably limited in the connecting slide groove 213. In this way, the pushing rod 21 is further prevented from being separated from the support base 22.

Furthermore, the support connecting assembly 20 further includes a support adjustment member 214, the support adjustment member 214 is detachably connected to an end of the pushing rod 21 away from the support base 22, and the first pushing surface 211 is formed at an end of the support adjustment member 214 away from the support base 22.

Support adjustment members 214 with pushing surfaces at different dip angles can be replaced by means of detachable connection according to mounting requirements, widening the device application range.

Furthermore, the support adjustment member 214 is provided with a first sliding column 215, and the mounting housing 10 is provided with a first slide groove 12 extending in the first direction and matched with the first sliding column 215.

This technical solution improves the sliding stability of the support adjustment member 214, and further improves the mounting precision and the mounting stability.

Furthermore, the support adjustment member 214 and the pushing rod 21 are provided with slidable connecting structures or quick-release snap structures matched with each other. The support adjustment member 214 and the pushing rod 21 can be detachably matched through various structures, which are designed and selected according to different requirements. It can be understood that a plurality of support adjustment members 214 capable of being freely changed can be provided. Each of the first pushing surfaces 211 is arranged at a different angle, and correspondingly, the second pushing surface 31 of the operation connecting assembly 30 can also be adjusted to a different angle, realizing transmission of different strengths to adapt to different walls. For example, for a wall having high hardness, an angle between the first pushing surface 211 and the first direction is relatively large; and for a wall having low hardness, the angle between the first pushing surface 211 and the first direction is relatively small.

Furthermore, the operation connecting assembly 30 is provided with a second pushing surface 31 matched with the first pushing surface 211, the operation connecting assembly 30 is provided with a second sliding column 32, and the mounting housing 10 is provided with a second slide groove 13 extending in the second direction and matched with the second sliding column 32.

This technical solution improves the structural stability of slidable connection between the operation connecting assembly 30 and the mounting housing 10.

Furthermore, the operation connecting assembly 30 includes an operation screw 40 and a pushing driving member 35, the operation screw 40 is rotatably connected to the mounting housing 10 and is threadedly connected to the pushing driving member 35, the second pushing surface 31 is arranged on the pushing driving member 35, and the operation screw 40 is capable of being controlled to rotate to drive the pushing driving member 35 to move in the second direction. It can be understood that a plurality of pushing driving members 35 capable of being changed can be provided, and correspondingly, the second pushing surface 31 of each of the pushing driving members 35 is arranged at a different angle.

Through this technical solution, the operation screw 40 is threadedly connected to the pushing driving member 35, achieving a transmission effect of speed-reduction conversion of a rotation travel to a linear travel. It can be understood that in other embodiments, the transmission mode may be a gear fit structure or a worm gear structure, meeting speed-reduction transmission and transmission direction, correspondingly implementing the pushing of the first pushing surface 211. Alternatively, the transmission mode may also be eccentric wheel or motor driving, implementing conversion of large-travel input to small-travel power output, achieving precise stepless adjustment.

Furthermore, an adjustment nut 33 is embedded in the pushing driving member 35, the operation screw 40 is threadedly connected to the adjustment nut 33, and a head of the operation screw 40 is rotatably assembled to the mounting housing 10. The operation screw 40 is matched with the adjustment nut 33, whereby when the operation screw 40 is controlled to rotate, the operation screw 40 can drive the pushing driving member 35 to move under threaded transmission with the adjustment nut 33.

Furthermore, the support portion 222 is provided with a first slot 216 adjacent to the first pushing surface 211, and the pushing driving member 35 is provided with a second slot 34 snap-fitted and slidably connected to the first slot 216, adjacent to the second pushing surface 31. The support adjustment member 214 is tightly fitted with the pushing driving member 35, further improving the adjustment precision.

Furthermore, a side of a part of the mounting housing 10 corresponding to the mounting space 11 is open and is detachably connected to a cover 14. Therefore, the mounting of the support adjustment member 214 and the pushing driving member 35 is facilitated, and the support adjustment member 214 and the pushing driving member 35 are effectively prevented from falling off.

Furthermore, an edge of the mounting housing 10 is further provided with a strip 15 snap-fitted with the window treatment bracket rod 50. In this way, the mounting and the connection of the window treatment bracket rod 50 are facilitated.

A second aspect in the embodiments of the present disclosure provides a no-drill window treatment, including: the no-drill window treatment mounting system according to the first aspect and a window treatment body. The window treatment body is mounted to the window treatment bracket rod 50 of the no-drill window treatment mounting system.

It should be further noted that, in this description, relationship terms such as first and second are only used to distinguish an entity or operation from another entity or operation, but do not necessarily require or imply that there is any actual relationship or order between these entities or operations. In addition, terms “include”, “comprise”, or their any other variations are intended to cover a non-exclusive inclusion, such that a process, a method, an article, or a device that includes a series of elements not only includes those elements, but also includes other elements that are not explicitly listed, or also includes inherent elements of the process, the method, the article, or the device. In the case that there are no more restrictions, an element limited by the statement “includes a . . . ” does not exclude the presence of additional identical elements in the process, the method, the article, or the device that includes the element.

The above description of the disclosed embodiments can enable a person skilled in the art to implement or practice this application. Various modifications to the embodiments are readily apparent to a person skilled in the art, and the generic principles defined herein may be practiced in other embodiments without departing from the spirit or scope of this application. Thus, this application is not limited to the embodiments shown herein but falls within the widest scope consistent with the principles and novel features disclosed herein.

What is claimed is:

1. A no-drill window treatment mounting system, comprising: a window treatment bracket rod extending in a first direction and one or two window treatment bracket connectors adaptively connected to an end portion of the window treatment bracket rod, wherein the window treatment bracket connector comprises:
a mounting housing, wherein the mounting housing is adaptively connected to the window treatment bracket rod, and is provided with a mounting space that extends away from the window treatment bracket rod in the first direction and that communicates with outside;
a support connecting assembly, wherein the support connecting assembly is accommodated in the mounting space in a relative sliding manner in the first direction, and has a first end extending out of the mounting space and an opposite second end provided with a first pushing surface obliquely oriented relative to the first direction; and
an operation connecting assembly, wherein the operation connecting assembly is mounted in the mounting housing, has a first end configured as an operation end and an opposite second end provided with a second pushing surface in pushing fit with the first pushing surface, and is provided with a speed-reduction transmission structure extending in a second direction intersecting with the first direction, whereby the second pushing surface moves relatively in the second direction.

2. The no-drill window treatment mounting system according to claim 1, wherein the first direction is an axial direction of the window treatment bracket rod, the second direction is perpendicular to the first direction, and the first pushing surface is arranged within an angle between the first direction and the second direction.

3. The no-drill window treatment mounting system according to claim 1, wherein the support connecting assembly comprises:
a support base, wherein the support base comprises a connecting portion partially accommodated in the mounting space and a support portion that is connected to the connecting portion and that extends out of the mounting space in the first direction; and
a pushing rod, wherein the pushing rod is movably accommodated in the mounting space in the first direction, one end of the pushing rod is connected to the connecting portion, and the first pushing surface is arranged at another end of the pushing rod away from the connecting portion.

4. The no-drill window treatment mounting system according to claim 3, wherein the pushing rod and the support portion are in insertion fit, and the support connecting assembly further comprises an elastic member arranged between the pushing rod and the support portion.

5. The no-drill window treatment mounting system according to claim 4, wherein the pushing rod is provided with a mounting socket, the support portion is configured as a columnar body slidably sleeved over the mounting socket, the elastic member is disposed in the mounting socket, and two ends of the elastic member abut against an interior of the pushing rod and the support portion, respectively.

6. The no-drill window treatment mounting system according to claim 5, wherein the pushing rod is provided with a connecting slide groove, the support portion is provided with a limiting column extending outwards, and the limiting column is slidably limited in the connecting slide groove.

7. The no-drill window treatment mounting system according to claim 3, wherein the support connecting assembly further comprises a support adjustment member, the support adjustment member is detachably connected to an end of the pushing rod away from the support base, and the first pushing surface is formed at an end of the support adjustment member away from the support base.

8. The no-drill window treatment mounting system according to claim 7, wherein the support adjustment member is provided with a first sliding column, and the mounting housing is provided with a first slide groove that extends in the first direction and that is matched with the first sliding column; and/or,
the support adjustment member and the pushing rod are provided with slidable connecting structures or quick-release snap structures matched with each other.

9. The no-drill window treatment mounting system according to claim 3, wherein the operation connecting assembly is provided with a second sliding column, and the mounting housing is provided with a second slide groove that extends in the second direction and that is matched with the second sliding column.

10. The no-drill window treatment mounting system according to claim 9, wherein the operation connecting assembly comprises an operation screw and a pushing driving member, the operation screw is rotatably connected to the mounting housing and is threadedly connected to the pushing driving member, the second pushing surface is arranged on the pushing driving member, and the operation screw is capable of being controlled to rotate to drive the pushing driving member to move in the second direction.

11. The no-drill window treatment mounting system according to claim 10, wherein an adjustment nut is embedded in the pushing driving member, the operation screw is threadedly connected to the adjustment nut, and a head of the operation screw is rotatably assembled into the mounting housing; and/or,
the support portion is provided with a first slot adjacent to the first pushing surface, and the pushing driving member is provided with a second slot that is snap-fitted and slidably connected to the first slot and that is adjacent to the second pushing surface.

12. The no-drill window treatment mounting system according to claim 1, wherein a side of a part of the mounting housing corresponding to the mounting space is open and is detachably connected to a cover; and/or,
an edge of the mounting housing is further provided with a strip snap-fitted with the window treatment bracket rod.

13. A no-drill window treatment, comprising: the no-drill window treatment mounting system according to claim 1 and a window treatment body, wherein the window treatment body is mounted to the window treatment bracket rod.
